(19) United States
(12) Patent Application Publication
(10) Pub. No.: US 2006/0189276 A1
(43) Pub. Date: Aug. 24, 2006

(54) Methods and systems for intelligent adaptive gain control

(76) Inventors: Michael Halinski, Long Grove, IL (US); Edwin Moreno, Elgin, IL (US); Timothy Avicola, Crystal Lake, IL (US)

Correspondence Address: MCANDREWS HELD & MALLOY, LTD, 500 WEST MADISON STREET, SUITE 3400, CHICAGO, IL, 60661, US

(21) Appl. No.: 11/298,726

(22) Filed: Dec. 8, 2005

Related U.S. Application Data
(60) Provisional application No. 60/634,216, filed on Dec. 8, 2004.

(51) Int. Cl. H04B 7/00

(52) U.S. Cl. 455/66.1; 455/90.3

(57) ABSTRACT

A wireless enhancer for providing bidirectional amplification is provided. The wireless enhancer may be positioned in an automobile or other mobile vehicle and used to increase the ability of a user to communicate with an existing cell phone system. The wireless enhancer provides bidirectional amplification for multiple signal formats and self-monitors to deliver the maximum amplification to the user without creating an oscillation or overdriven condition.

### RELATED APPLICATIONS

This application claims the benefit of U.S. Provisional Application No. 60/634,216, filed Dec. 8, 2004.

### BACKGROUND OF THE INVENTION

The present invention generally relates to improving wireless communication over an existing wireless communication system. More specifically, the present invention relates to system and methods for improving communication over an existing cell-phone or other wireless network, especially when a user is positioned in an automobile.

Cell phone users may occasionally experience an undesired interruption of service due to a loss of signal. For example, the user's cell phone may no longer be able to receive a signal from a cellular tower or a satellite. Alternatively, the cellular tower or satellite may not be able to receive a signal from the user's cell phone.

Several design responses have been implemented both by cell phone manufacturers and by third party after manufacturers selling after market add-ons to cell phones. For example, the cell phone's antenna may be lengthened or the cell phone may be instructed to transmit at a higher power.

However, the previous solutions are constrained to operate within the constraints of size and power set by the consumer. Specifically, it is viewed as desirable to the consumer to manufacture the cell phone as small and light as possible. Consequently, the size of the cell phone's antenna and the weight of the cell phone's battery are constrained to be as small and light as possible. Designing an antenna that is large is not desired by the consumer and transmitting at a higher power drains the cell phone's battery too quickly.

Additionally, transmitting at a higher power only helps the cell phone transmit a message to the cell phone system. Increasing the ability of the cell phone to receive messages from the system may require additional components that may increase the weight and power demands of the cell phone.

Thus, a need has long been felt for a system that improves cell phone communication. A need has especially been felt for a system that minimizes loss of service by amplifying signals received from the cell phone service and signals transmitted to the cell phone service.

### BRIEF SUMMARY OF THE INVENTION

One or more of the embodiments of the present invention provide a wireless enhancer for providing bidirectional amplification for use in assisting cell phone communication. The wireless enhancer may be positioned in an automobile and may be powered by power received from the automobile. The wireless enhancer acts as an unseen intermediary between the user's cell phone and the cellular system to increase the reliability of the cell phone communication. As further described below, the wireless enhancer supports multiple signal formats and continuously self-monitors to increase amplification to the maximal level without creating an overdriven condition.

### BRIEF DESCRIPTION OF SEVERAL VIEWS OF THE DRAWINGS

FIG. 1 illustrates a wireless enhancer according to an embodiment of the present invention.

FIG. 2 illustrates a flow chart of an improved method of amplification for use in the wireless enhancer of FIG. 1.

FIG. 3 illustrates a flowchart the initialization process for the wireless enhancer in greater detail.

FIG. 4 illustrates a flowchart of the initialization of the I/O port.

FIG. 5 illustrates a flowchart of the initialization of the timers.

FIG. 6 illustrates a flowchart of the timer0_init process.

FIG. 7 illustrates a flowchart of the initialization of the ADC

FIG. 8 illustrates a flowchart of the initialization of the attenuators.

FIG. 9 illustrates a flowchart of the FindCeiling process.

FIG. 10 illustrates a flowchart of a process for sampling the signal level on a signal pathway.

FIG. 11 illustrates a block diagram of an alternative embodiment of the wireless enhancer of FIG. 1.

FIG. 12 illustrates a port layout for the alternative embodiment of FIG. 11.

### DETAILED DESCRIPTION OF THE INVENTION

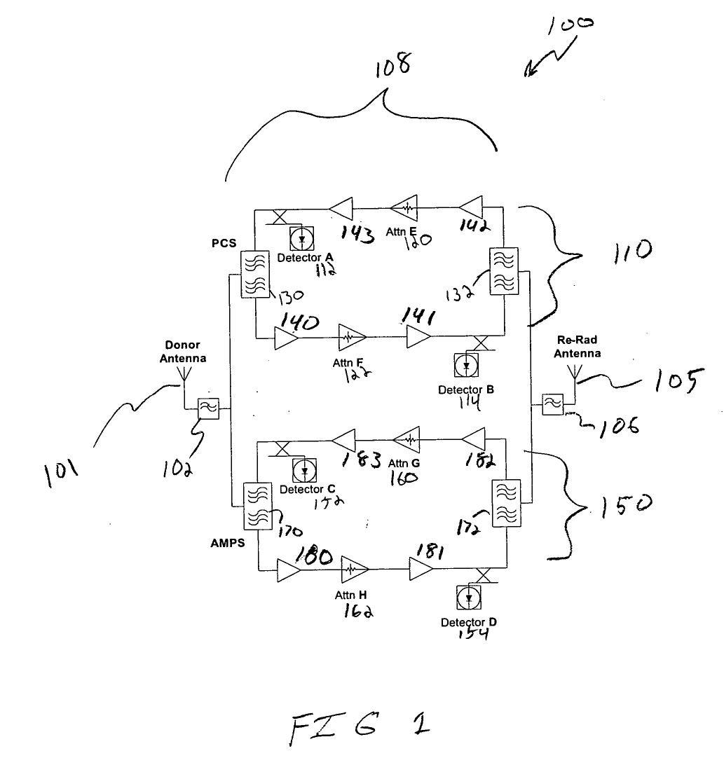

FIG. 1 illustrates a wireless enhancer 100 according to an embodiment of the present invention. The wireless compensation 100 includes a donor antenna 101, a re-radiation antenna 105 and an amplifier unit 108. The amplifier unit 108 includes a Personal Communication Services (PCS) amplification system 110 and an Advanced Mobile Phone Service (AMPS) amplification system 150. The donor antenna 101 is associated with a donor filter 102. The re-radiation antenna 105 is associated with a re-radiation filter 106.

The PCS amplification system 110 includes a detector A 112, a detector B 114, an attenuator E 120, an attenuator F 122, a PCS front end duplexer 130, a PCS back end duplexer 132, and a plurality of PCS amplifiers 140-143.

The AMPS amplification system 150 includes a detector C 152, a detector D 154, an attenuator G 160, an attenuator H 162, an AMPS front end duplexer 170, an AMPS back end duplexer 172, and a plurality of AMPS amplifiers 180-183. Additionally, the duplexers 130, 132, 170, 172 may provide filtering as well.

As shown in FIG. 1, the donor antenna 101 is connected to the donor filter 102 which is in turn connected to both the PCS front end duplexer 130 and the AMPS front end duplexer 170. The re-radiation antenna 105 is connected to the re-radiation filter 106 which is in turn connected to both the PCS back end duplexer 132 and the AMPS back end duplexer 172.

Turning now to the PCS amplification system 110, the PCS front end duplexer 130 is connected to the amplifier 140 which is in turn connected to the attenuator F 122. The attenuator F 122 is connected to the amplifier 141 which is in turn connected to the detector B 114. The detector B is connected to the PCS back end duplexer 132.

Additionally, the PCS back end duplexer 132 is connected to the amplifier 142 which is in turn connected to the attenuator E 120. The attenuator E 120 is connected to the amplifier 143 which is in turn connected to the detector A 112. The detector A is connected to the PCS front end duplexer 130.

Turning now to the AMPS amplification system 150, the AMPS front end duplexer 170 is connected to the amplifier 180 which is in turn connected to the attenuator H 162. The attenuator H 162 is connected to the amplifier 181 which is in turn connected to the detector D 154. The detector D is connected to the AMPS back end duplexer 172.

Additionally, the AMPS back end duplexer 172 is connected to the amplifier 182 which is in turn connected to the attenuator G 160. The attenuator G 160 is connected to the amplifier 183 which is in turn connected to the detector C 152. The detector C is connected to the AMPS front end duplexer 170.

In operation, either PCS or AMPS signals may be received at the donor antenna 101, pass through the amplifier unit 108, and be re-transmitted at the re-radiation antenna 105. Thus, for example, in the case that a user may desire to use a PCS cell phone, but the PCS signal may be too weak for the user's cell phone to properly operate, the weak PCS signal may be received by the wireless enhancer 100 and re-transmitted to the user's cell phone at a higher amplitude to enable the user to use the PCS system. Similarly, either PCS or AMPS signals may be received at the re-radiation antenna 105, pass through the amplifier unit 108, and be re-transmitted at the donor antenna 101. Thus, in the exemplary case of the PCS cell phone system, the signal generated by the user's cell phone may also be received by the wireless enhancer 100 and then amplified and transmitted to the next stage in the PCS system, such as a cell phone tower, for example. Thus, the wireless enhancer 100 may assist in increasing the ability of a user to communicate using a PCS or AMPS communication system in an environment where the amplitude of the PCS or AMPS signal is low.

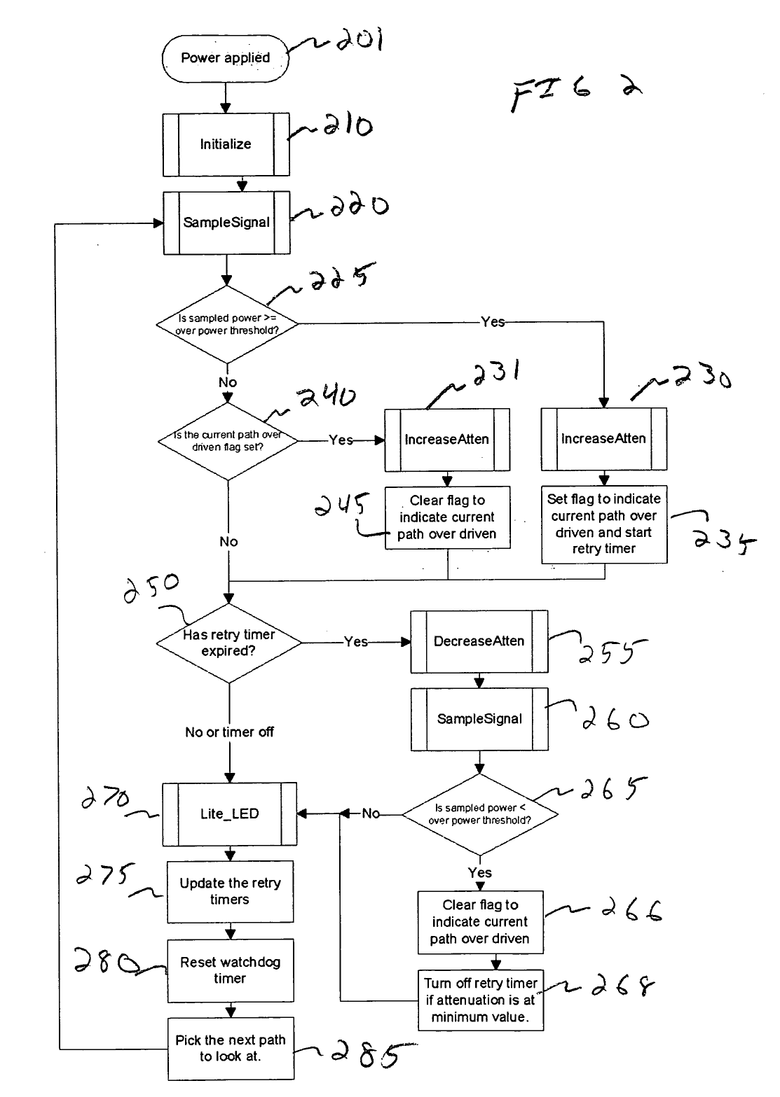

When the wireless enhancer 100 is used in a PCS system, the wireless enhancer operates as follows. First, a PCS signal is received at the donor antenna 101. The signal may be received from a cell phone tower, satellite, or other PCS device, for example. The PCS signal then passes to the donor filter 102. The donor filter is preferably a large band pass filter that passes frequencies for both the PCS and AMPS bands. From the donor filter 102, the received PCS signal passes to the PCS front end duplexer 130. The PCS signal is then passed to the amplifier 140, which amplifies the PCS signal. The PCS signal is then passed to the attenuator F 122 where the signal is attenuated. The signal then passes through an additional amplifier 141 that amplifies the signal. After the signal is amplified by the amplifier 141, the signal is measured at the detector B 114. The details of the interrelation of the amplifiers 140, 141, the attenuator F 122 and the detector B 114 are detailed below with regard to FIGS. 2-10.

After the detector B 114, the signal passes to the PCS back end duplexer 132 and then to the re-radiation filter 106. Like the donor filter, the re-radiation filter is preferably a large band pass filter that passes frequencies for both the PCS and AMPS bands. The signal then passes from the re-radiation filter 106 to the re-radiation antenna 105 which re-radiates the signal. The re-radiated signal is then preferably received by another device, such as a user's cell phone for example.

When it is desired to send a reply from the device that received the signal from the re-radiation antenna 105, the device generated a PCS reply signal. The PCS reply signal is received by the re-radiation antenna 105 and then passes through the re-radiation filter 106 to the PCS back end duplexer 132. The signal then passes through the upper pathway shown in FIG. 1, which comprises the amplifier 142, the attenuator E 120, the amplifier 143, and the detector A 112 in succession. After the detector A, the reply signal is passed to the PCS front end duplexer 130 and travels through the donor filter 102 to the donor antenna 101. The donor antenna 101 transmits the amplified signal to another device, such as a cell phone tower or a satellite, for example.

The AMPS amplification system 150 functions similarly to the PCS amplification system 110, but operates in the AMPS frequency band rather than the PCS frequency band. That is, an AMPS signal is received at the donor antenna 101 and then passes through the donor filter 102 to the AMPS front end duplexer. The signal then passes through following in succession: the amplifier 180, the attenuator 162, the amplifier 181, the detector D 154, the AMPS back end duplexer 172, the re-radiation filter 106 and the re-radiation antenna 105. As mentioned above, the signal transmitted by the re-radiation antenna 105 is preferably received by another device which also typically generates a reply. The reply signal is then received by the re-radiation antenna 105 and then passes through the following in succession: the re-radiation filer 106, the AMPS back end duplexer 172, the amplifier 182, the attenuator G 160, the amplifier 183, the detector 152, the AMPS front end duplexer 170, the donor filter 102, and the donor antenna 101. As mentioned above, the donor antenna 101 transmits the amplified signal to another device, such as a cell phone tower or a satellite.

Several alternatives are available for use with the embodiment described above. First, although the wireless enhancer 100 shown in FIG. 1 is shown for use with both an AMPS and PCS system, the enhancer may be implemented for a use with a single system instead. For example, the wireless enhancer may be implemented for use in only a PCS system, in which instance the AMPS amplification system 150 is removed and only the PCS amplification system 110 remains. Alternatively, the wireless enhancer may be implemented for only the AMPS amplification system 150 and no PCS amplification system 110.

Additionally, other amplification systems may be included in the wireless enhancer 100. That is, although FIG. 1 illustrates the AMPS and PCS communication formats, other communication formats may be supported. For example, an iDEN amplification system may also be provided in addition to the PCS and AMPS amplification systems. The iDEN amplification system preferably includes the same circuitry as the PCS and AMPS systems, but the circuitry is adjusted for use in the iDEN band. In this embodiment, the donor filter 102 and re-radiation filter 106 are also preferably configured to pass signals in the iDEN band, as well as the PCS and AMPS band. Additional communication bands may also be added to the wireless enhancer. Also, the wireless enhancer may include any subset of one or more of the PCS, AMPS, iDEN or additional bands.

Typical filter values employed include the following

| | | | |
|---|---|---|---|
| PCS | UPLINK | 1850-1910 | MHz |
| | DOWNLINK | 1930-1990 | MHz |
| AMPS | UPLINK | 824-849 | MHz |
| | DOWNLINK | 869-894 | MHz |
| iDEN | UPLINK | 806-821 | MHz |
| | DOWNLINK | 851-866 | MHz |

Additional embodiments of the wireless enhancer may provide amplification for additional communication bands such as GSM 900 and DCS 1800.

Thus, the wireless enhancer is a relatively low-cost, dual band bidirectional enhancer which preferably delivers about 50 dB of gain. The wireless enhancer may be implemented as a package composed of three pieces, the donor antenna, the amplifier unit, and the re-radiation antenna. Additionally, the donor antenna is preferably glass mounted, but other types of mountings may be employed.

Also, although the wireless enhancer is preferably implemented in an automobile or other mobile unit, the wireless enhancer may be positioned in any area in with signal repeating or increased signal strength is desired. For example, in the home, an office, a boat, or recreational vehicle.

Further, the wireless enhancer may be used to provide amplification for both PCS and AMPS at the same time. Similarly, in an embodiment including iDEN amplification, the iDEN amplification may take place at the same time that the PCS and/or AMPS amplification is provided.

FIG. 2 illustrates a flow chart 200 of an improved method of amplification for use in the wireless enhancer of FIG. 1. First, at step 201, the power is applied to the wireless enhancer. For example, when the wireless enhancer is implemented in an automobile, power may be applied to the wireless enhancer when the automobile ignition is triggered or when a switch is actuated by a user.

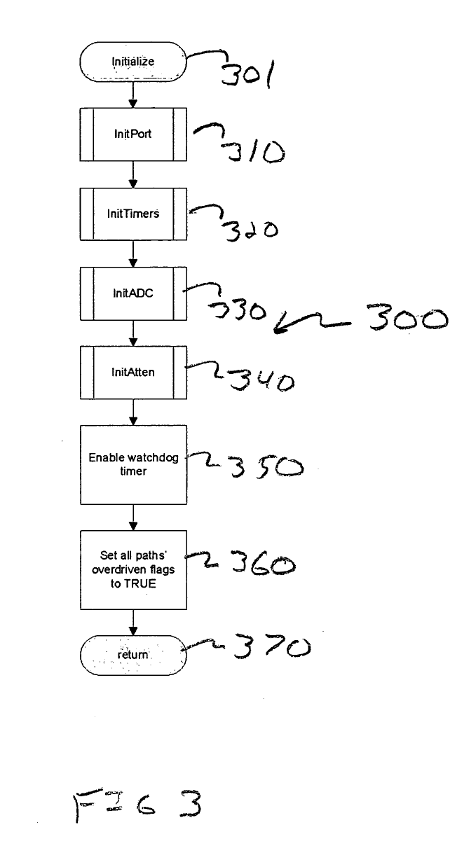

Once power has been applied at step 201, the flowchart proceeds to step 210 and the initialization process for the wireless enhancer is initiated. The initialization process is further set forth in FIG. 3, below. Once the initialization process has been completed, the flowchart proceeds to step 220.

In the flowchart 200 of FIG. 2, the steps 220-285 are repeated for each signal path. The wireless enhancer of FIG. 1 includes four signal paths. The first signal path includes the amplifier 142, the attenuator E 120, the amplifier 143, and the detector A 112. The second signal path includes the amplifier 140, the attenuator F 122, the amplifier 141, and the detector B 114. The third signal path includes the amplifier 182, the attenuator G 160, the amplifier 183, and the detector C 152. The fourth signal path includes the amplifier 180, the Attenuator 162, the amplifier 181, and the detector D 154.

If the wireless enhancer is implemented according to one of the alternatives presented above to only provide amplification for PCS signals, for example, then the wireless enhancer would only have two signal paths. Consequently, steps 220-285 of the flowchart 200 of FIG. 2 would only be repeated twice. Alternatively, if the wireless enhancer of FIG. 1 is altered to also include amplification for iDEN signals, then the enhancer would include six paths and the steps 220-285 would be repeated six times.

Turning to step 220, for a particular signal path, the signal level or signal power is sampled using the relevant detector. For example, for the first signal path, the signal level is sampled or measured using the detector A 112.

Next, at step 225, the sampled power level is compared to the overpower threshold. The overpower threshold is a pre-selected power level that has been chosen to aid in the determination of when an oscillation condition has occurred. Oscillation occurs when the gain is greater than the antenna isolation. As further described below, the wireless enhancer continuously monitor for an oscillation condition. An oscillation saturates the signal path, resulting in a large output signal. As further described below, the detectors A-D are used to detect an oscillation by measuring the output power of each signal path. When the measured power on a signal path exceeds a threshold, one or more of the amplifiers in the signal path are assumed to be oscillating or in an overdrive condition. As further described below, when an oscillation (or overdrive) is detected, the attenuation of the specific attenuator E-H is increased one step at a time until the oscillation ceases.

As further described below, there are four thresholds used in the wireless enhancer, two for AMPS and two for PCS. Specifically, each of the AMPS and PCS systems includes an uplink threshold and a downlink threshold. The actual value of the thresholds may vary depending upon the actual implementation of the wireless enhancer. For example, the use of different antenna components may provide varying antenna isolation that may impact the threshold.

Returning to step 225, if the sampled power is equal to or greater than the overpower threshold, then the process proceeds to step 230 and the attenuation of the attenuator is increased. For example, in the first signal path, when the detector A 112 measures the signal power and compares it to a threshold, if the signal power is greater than or equal to the threshold, then the attenuation of the attenuator E 120 is increased.

The attenuators E-H are preferably configured to include a large number of different selectable attenuation levels so that the attenuation of a signal path may be adjusted in small increments. Preferably, the attenuators include at least 64 selectable power levels which may also be known as attenuation steps.

Returning to step 230, once the attenuation level for the attenuator has been increased, the process proceeds to step 235 and a flag is set to indicate that the current signal is over driven or that an oscillation condition has occurred on the path. Additionally, at step 235, the retry timed is started. The process then proceeds to step 250.

Returning to step 225, if the sampled power is less than the overpower threshold, then the process proceeds to step 240. At step 240, the process determines whether the path overdriven flag has been set for the current signal path. The oath overdriven flag may have been set, for example, at step 235 during a previous iteration of steps 220-285. If the path overdriven flag has been set, then the process proceeds to step 231 and the attenuation of the relevant attenuator is increased. The process then proceeds to step 245 and the path overdriven flag is cleared. Clearing the path overdriven flag provides an indication that the signal path is no longer overdriven.

Thus, steps 225-245 operate to measure the power of one of the signal paths and compare the power to the overpower threshold. As mentioned below with regard to the initiation procedure, each of the attenuators E-H is initially set at the lowest attenuation level. Consequently, steps 225-245 act to gradually increase the attenuation level of attenuator for a particular signal path to lower the signal level for the signal path below the overpower threshold. Preferably, as mentioned above, the attenuators include a plurality of attenuation steps. Thus, the attenuator may be initialized at the lowest step and increased step-by-step until the observed signal power for the path is less than the overpower threshold.

Additionally, once the observed signal power for the path is less than the overpower threshold, the attenuator may be increased by one more step at steps 240-245 in order to provide a buffer between the current signal power level of the path and the overpower threshold.

Turning now to step 250, the process determines whether the retry timer has expired. The retry timer may have been started, for example, at step 235. The retry timer is a pre-determined time period during which the enhancer does not attempt to reduce the attenuation of the signal path. Conversely, once the retry timer has elapsed, the attenuation for that signal path is decreases, as further described below, in order to attempt to achieve the maximum signal power for the signal path without creating an overdriven or oscillation condition. The retry time may preferably be between 1 and 2 seconds in length.

At step 250, if the retry time has expired, then the process proceeds to step 255 and the attenuation is decreased. For example, for the first signal path, if the retry time has expired, then the attenuation of the attenuator E 120 is reduced, preferably by a single step. Once the attenuation is decreased, at step 260 the signal level for the signal path is sampled, for example using the detector A 112. The process then proceeds to step 265.

At step 265, the sampled power is compared to the overpower threshold. If the sampled power is less than the overpower threshold, then the process proceeds to step 266 and the flag indicating a path overdriven condition is cleared in order to indicate that the current path is not overdriven.

Next, at step 268, the process determines if the attenuation of the attenuator is set at its lowest value. If the attenuation of the attenuator is at its lowest value, then the retry timer is turned off. The process then proceeds to step 270.

Returning now to step 265, if the sampled power is not less than the overpower threshold, then the process proceeds directly to step 270.

Returning now to step 250, if the retry timer has not expired or the retry timed is turned off, then the process proceeds directly to step 270.

Turning now to step 270, at step 270, the LED is lit. The wireless enhancer preferably includes a tri-color LED. The color of the LED is preferably determined by the attenuator value. For example, the color of the LED may be green, yellow, or red and the attenuator may include 64 attenuation steps. In this example, the green color may be used to indicate normal operation. That is, that no oscillation was detected or a “minor” oscillation was detected. In this instance, the attenuator value is typically between 64 to 43 steps up from the minimum attenuator value. The yellow color may be used to indicate that oscillation was detected. In this instance, the attenuator value is typically between 42 to 30 steps up. The red color may be used to indicate that major was detected. In this instance, the attenuator value is typically between 29 to 0 steps up.

The process then proceeds to step 275 and the retry timer for the signal path is updated. For example, the amount of time that has elapsed since the retry timer was set may be determined to update the retry timer.

Next, at step 280, a watchdog timer may be reset. The watchdog timer may be useful when that processor performing the process of FIG. 2 becomes locked up or otherwise halts. The watchdog timer may be an interrupt-driven low-level function call that may cause the process to restart if the process if the watchdog timer is not periodically updated. Alternatively, the watchdog timer may cause the enhancer to reinitialize if the watchdog timer is not periodically updated.

Next, at step 285, the process chooses the next signal path for processing. The flowchart then proceeds back to step 220 and performs steps 220-285 for the new signal path. Steps 220-285 preferably take place over and over again for each of the four signal paths in succession.

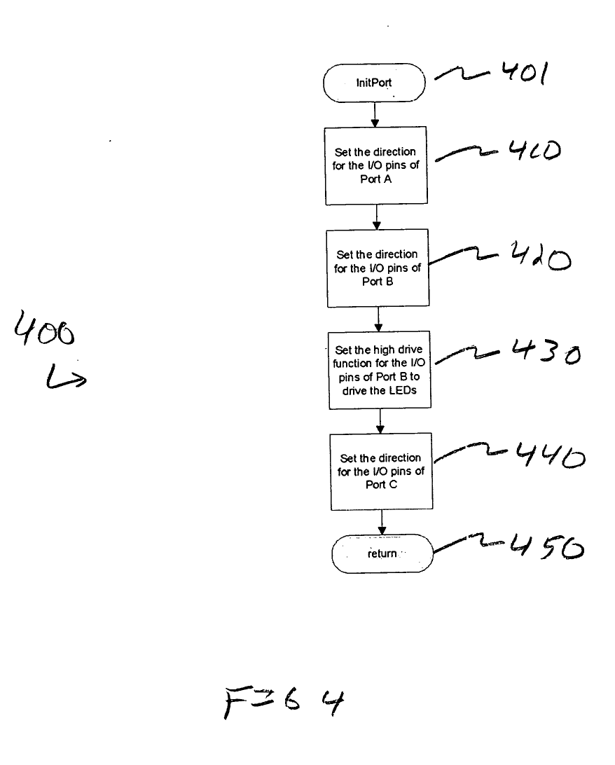

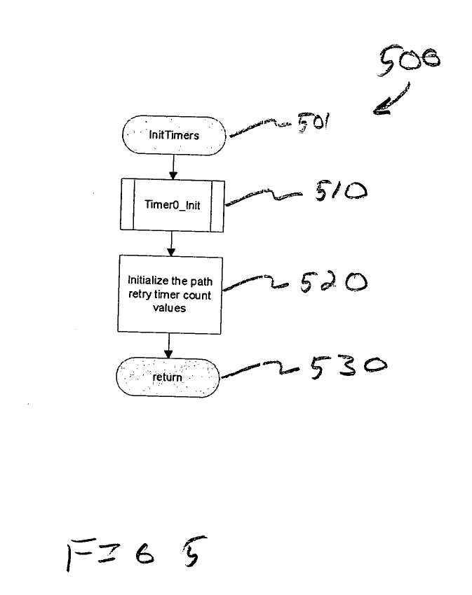

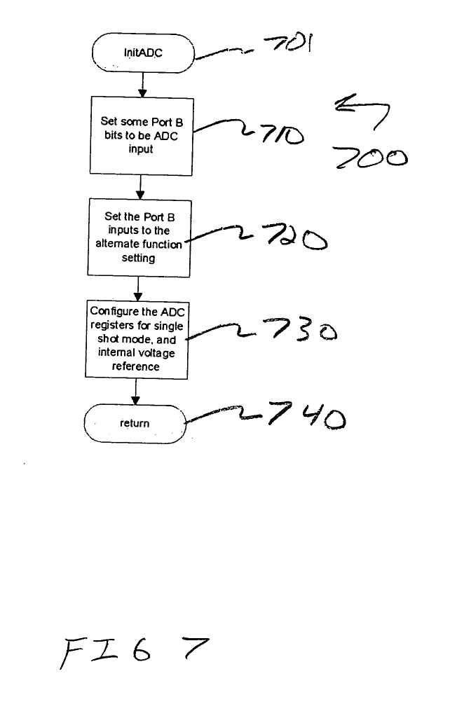

FIG. 3 illustrates a flowchart 300 the initialization process for the wireless enhancer in greater detail. First at step 301, the initialization process is initiated. For example, the initialization process may be called during step 210 of the flowchart 200 of FIG. 2. At step 310, the input/output (I/O) port is initialized. The initialization of the I/O port is further detailed in FIG. 4, below. Once the I/O port has been initialized at step 310, the process proceeds to step 320 and the timers are initialized. The initialization of the timers is further detailed in FIG. 5, below. Once the timers have been initialized at step 320, the process proceeds to step 330 and the ADC is initialized. The initialization of the Analog-To-Digital Converter (ADC) is further detailed in FIG. 7, below.

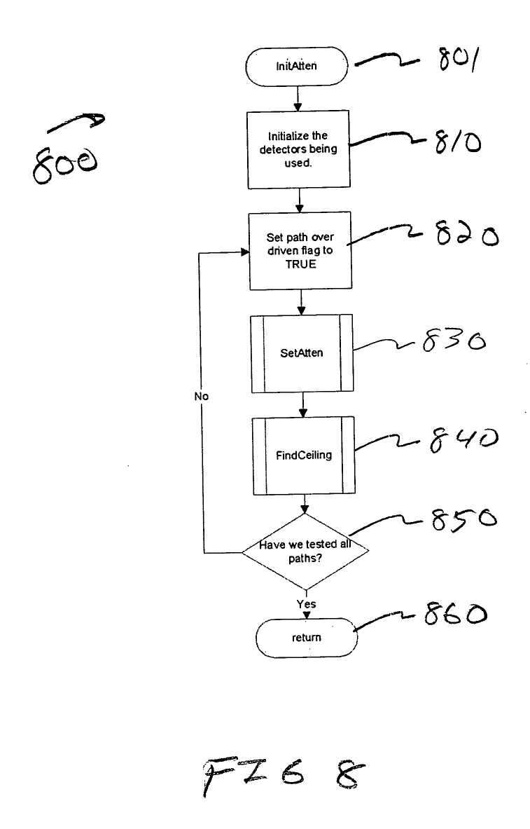

Once the ADC has been initialized at step 330, the process proceeds to step 340 and the attenuators are initialized. The initialization of the attenuators is further detailed in FIG. 8, below. Once the attenuators have been initialized at step 340, the process proceeds to step 350 and the watchdog timer is enabled. Then, at step 360, the overdriven flags for all paths are set to true. That is, as further described below, during the initialization process, all of the attenuators are set to their lowest attenuation settings. Thus, the signal power for each of the signal paths is at its maximum value and is highly likely to be above the overdriven threshold. Consequently, the overdriven flags are set for each of the signal paths. Finally, at step 370, control passes back to the flowchart that called for the initialization process. For example, when the initialization process was called at step 210 of the flowchart 200 of FIG. 2, the process may then proceed to step 220 of FIG. 2.

FIG. 4 illustrates a flowchart 400 of the initialization of the I/O port. First at step 401, the initialization process is initiated. For example, the initialization of the I/O port may be called during step 310 of the flowchart 300 of FIG. 3. At step 410, the direction for the I/O pins of Port A is set. Next, at step 420, the direction for the I/O pins of Port B is set. Next, at step 430, the high drive function for the I/O pins of Port B is set in order to drive the LEDs. Then at step 440, the direction for the I/O pins for Port C is set. Finally, at step 450, control passes back to the function that called for the initialization of the I/O port. For example, when the initialization of the I/O port was called at step 310 of the flowchart 300 of FIG. 3, the process may then proceed to step 320 of FIG. 3.

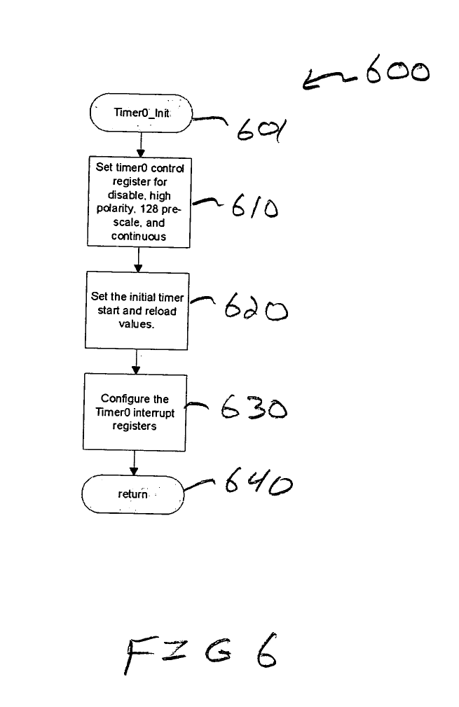

FIG. 5 illustrates a flowchart 500 of the initialization of the timers. First, at step 501, the initialization process is initiated. For example, the initialization of the timers may be called during step 320 of the flowchart 300 of FIG. 3. At step 510, the timer0_init process is initiated. The initialization of the timer0_init process is further detailed in FIG. 6, below. Once the timer0_init process of step 510 has been accomplished, the flowchart proceeds to step 520 and the path retry timer count value is initialized. The path retry timer is used, for example in step 250 of FIG. 2, and is set to a specific value, such as 2 seconds, at step 520. Finally, at step 530, the control passes back to the flowchart that called the initialization of the timer. For example, when timer initialization was called at step 320 of the flowchart 300 of FIG. 3, the process may then proceed to step 330 of FIG. 3.

FIG. 6 illustrates a flowchart 600 of the timer0_init process. First, at step 601, the timer0_init process is initiated. For example, the initialization of the timer0_init process may be called during step 510 of the flowchart 500 of FIG. 5. At step 610, the timer0 control register is set for disable, high polarity, 128 pre-scale, and continuous. That is, the values and commands set the timer zero configuration to count at a rate of about 1 microsecond per increment or tic. This is used to create system event timers as further described below.

Next, at step 620, the initial timer start is set and the reload values are set. That is, the time is set to an initial value and, when started, counts down to zero. When zero is reached, an interrupt is generated and the software is automatically redirected to code that handles the interrupt (an interrupt handler). Within the interrupt handle, the time is reloaded with the initial value and restarted. Then any system counter and timer variables are updated to reflect the time elapsed.

Next, at step 630, the timer0 interrupt registers are configured. This is housekeeping for the timer zero interrupt.

Finally, at step 640, the control passes back to the flowchart that called the timer0_init process. For example, when the timer0_init process was called at step 510 of the flowchart 500 of FIG. 5, the process may then proceed to step 520 of FIG. 5.

FIG. 7 illustrates a flowchart 700 of the initialization of the ADC. First at step 701, the initialization process is initiated. For example, the initialization of the ADC may be called during step 330 of the flowchart 300 of FIG. 3. At step 710, some Port B bits are set to be the ADC input.

This is, the specific microcontroller used in this embodiment of the wireless enhancer includes pins that may be configured for any of several uses. During startup, the pins are configured as desired. That is, the ADC input pins are configured to be ADC analog input, not digital output.

Next, at step 720, the Port B inputs are set to the alternate function setting.

Then, at step 730, the ADC registers are configured for single short mode and internal voltage reference. That is, in this embodiment, the ADC is built into the microcontroller and the specifics regarding how the ADC converts are configurable. In this step the ADC parameters are configured to perform the conversion in the preferred manner for the present application.

Finally, at step 740, the control passes back to the flowchart that called the initialization of the ADC. For example, when ADC initialization was called at step 330 of the flowchart 300 of FIG. 3, the process may then proceed to step 340 of FIG. 3.

FIG. 8 illustrates a flowchart 800 of the initialization of the attenuators. First at step 801, the initialization process is initiated. For example, the initialization of the attenuators may be called during step 340 of the flowchart 300 of FIG. 3. At step 810, the detectors are initialized. For example, power may be supplied to the detectors and the detectors may perform internal diagnostics.

Although step 810 acts to initialize the detectors for all of the signal paths, the remaining steps 820-850 repeat for each of the signal paths independently. That is, steps 820-850 proceed for the first signal path and then repeat for the second signal path, and so on.

At step 820, a specific path is selected and the path overdriven flag for that path is set to TRUE. For example, using the wireless enhancer of FIG. 1, the first path including the attenuator E 120 may be selected and its associated overdriven flag set to true. Then, at step 830, the SetAtten process is called. The SetAtten process sets the attenuator for the specific signal path to the minimum attenuation level. Consequently, the signal level for the signal path is at its maximum.

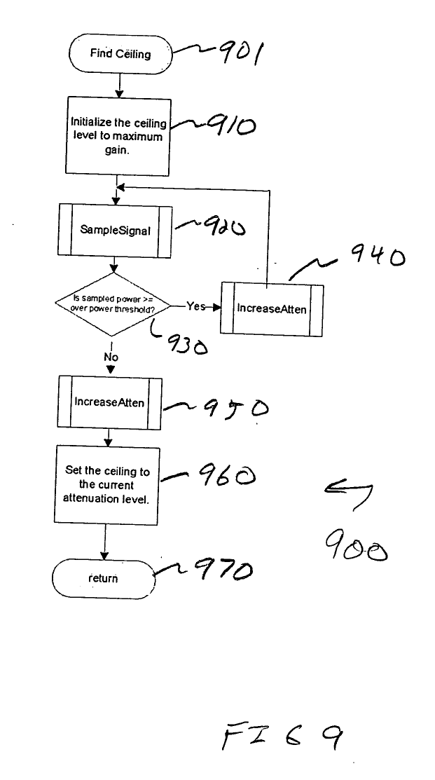

The process then proceeds to step 840 and the Find Ceiling process is called. The Find Ceiling is further detailed in FIG. 9, below. Once the Find Ceiling process has been accomplished at step 840, the flowchart proceeds to step 850 and queries whether all paths have been tested. That is, the series of steps 820-850 proceeds for each of the attenuators E-H 120, 122, 160, 162, so that for each attenuator the path overdriven flag is set, the Set Atten process is called and the Find Ceiling process is called. Once all of the attenuators have been initialized, the process proceeds to step 860. Finally, at step 860, the control passes back to the flowchart that called the initialization of the attenuators. For example, when attenuator initialization was called at step 340 of the flowchart 300 of FIG. 3, the process may then proceed to step 350 of FIG. 3.

FIG. 9 illustrates a flowchart 900 of the FindCeiling process. First, at step 901, the FindCeiling process is initiated. For example, the FindCeiling process may be called during step 840 of the flowchart 800 of FIG. 8. As shown in FIG. 8, the FindCeiling process is repeated for each of the attenuators 120, 122, 160, 162, in the enhancer 100. Also, as shown in FIG. 8, before the FindCeiling process is called, the attenuator value for the attenuator is set to its minimum level.

At step 910, the ceiling level for the attenuator is initialized to the attenuator's maximum gain value, which is the lowest attenuation level. Next, at step 920, the signal level for the signal path is sampled using the detector in the same signal pathway as the attenuator. For example, when the FindCeiling process is being applied to the attenuator E 120, the signal level is sampled using the detector A 112.

Once the signal has been sampled, the flowchart 900 proceeds to step 930 and the signal level is compared to the overpower threshold. If the signal level is greater than or equal to the overpower threshold, then the flowchart proceeds to step 940 and the attenuation of the attenuator is increased. The process then proceeds back to step 920 and the signal level is sampled again.

Conversely, at step 930, if the signal level is less than the overpower threshold, than the process proceeds to step 950 and the attenuation is increased. The process then proceeds to step 960 and the ceiling for the attenuator is set to the current attenuation level. Finally, at step 970, the control passes back to the flowchart that called the FindCeiling process. For example, when FindCeiling process is called at step 840 of the flowchart 800 of FIG. 8, the process may then proceed to step 850 of FIG. 8.

The ceiling level may be used to determine the maximum signal level for a specific pathway. The maximum signal level is associated with a minimum attenuation level at the attenuator occupying the signal pathway. That is, in the example wherein the attenuator has many attenuation steps, the process gradually increases the attenuation until it determines the first attenuation step that does not result in an overdriven condition. The process then sets the ceiling level to the attenuation step prior to the first attenuation step that does not result in an overdriven condition.

That is, the ceiling is used for setting the maximum possible gain when the user's signal is very strong and very close to the enhancer's antenna. The ceiling is preferably recalculated once every time the system is powered up. The enhancer then operates in a way to not increase the gain beyond the ceiling in order to prevent possible oscillation or overdrive conditions. Thus, the ceiling is used as a threshold that is not exceeded. The ceiling is the amplification level at which the system generates a maximum possible gain for the current antenna isolation without inducing overdrive. That is, the system is powered up at maximum gain and then looped, with the gain lowered on successive loops until the overdrive condition is eliminated. That attenuation level is then stored as the minimum level that can be used. Thus, the ceiling ensures that the antenna will not overdrive in its current environment.

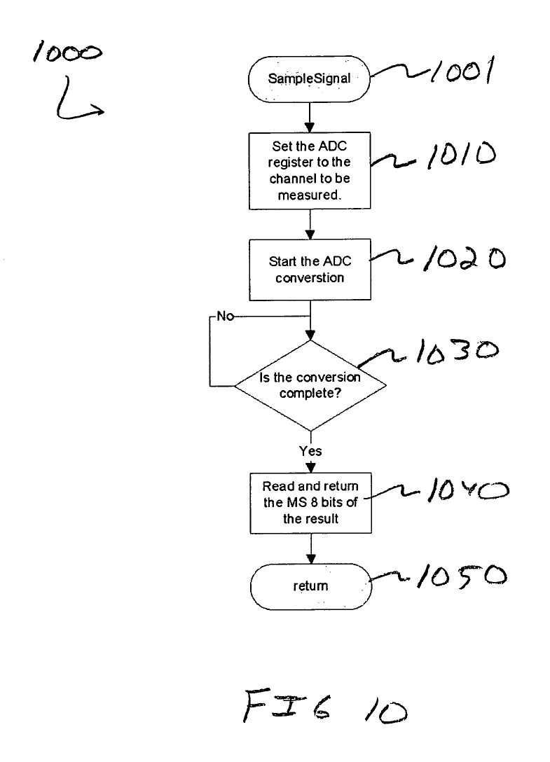

FIG. 10 illustrates a flowchart 1000 of a process for sampling the signal level on a signal pathway. The process of FIG. 10 may be called, for example, by step 220 of FIG. 2 or step 920 of FIG. 9. At step 1001, the signal sample process is initiated. Next, at step 1010, the ADC register is set to the channel to be measured. Then, at step 120, the ADC conversion is started. The process then proceeds to step 1030 which determined whether the ADC conversion is complete. If the conversion is not complete, then the process re-enters step 1030 and re-checks for completion after a short delay. If the conversion is complete, then the process proceeds to step 1040 and the most significant 8 bits of the result of the ADC conversion are read and returned. Finally, at step 1050, the control passes back to the flowchart that called the signal sample process.

That is, the software configures and initiates the ADC process to sample the analog signal present at the input pin. The software then waits until the process completes and has obtained a digital value for use. when the ADC conversion is finished, the digital value may then be read from an ADC register.

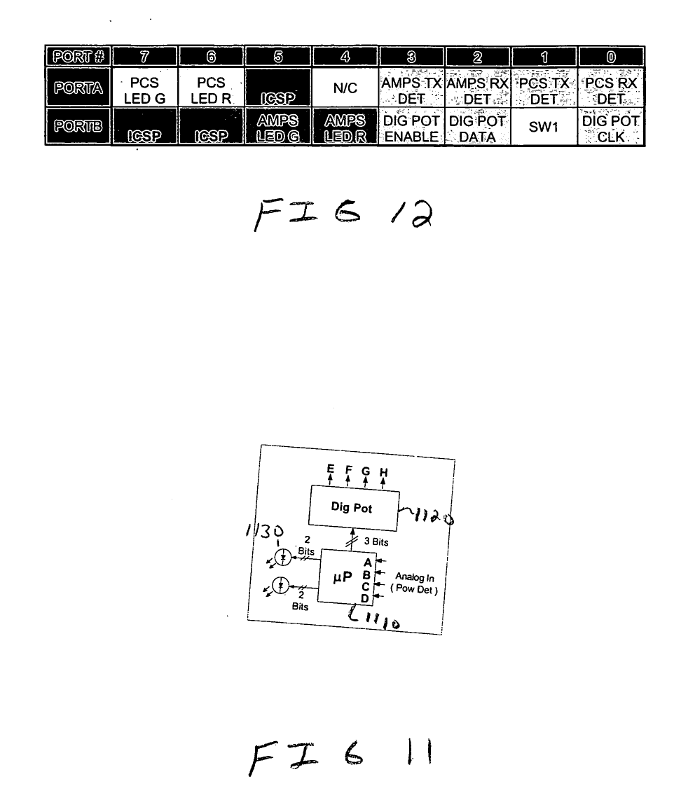

FIG. 11 illustrates a block diagram of an alternative embodiment 1100 of the wireless enhancer of FIG. 1. FIG. 11 includes a microprocessor 1110, a digital potentiometer 1120, and two LEDs 1130. As shown in FIG. 11, the microprocessor 1110 received analog inputs from the detectors A-D. The microprocessor 1110 may then proceed through the process of FIG. 2 to determine an attenuation level to apply to one or more of the attenuators E-H via the digital potentiometer 1120. Additionally, instead of using only a single LED as recited in the process of FIG. 2, the alternative embodiment of FIG. 11 may use a plurality of LEDs 1130. For example, one LED may related to PCS functionality and one LED may related to AMPS functionality.

FIG. 12 illustrates a port layout 1200 for the alternative embodiment of FIG. 11. As shown in the port layout 1200, Port A receives the values from the detectors A-D for both the AMPS and PCS systems. Specifically, detector A from the PCS receive path is detected at port A, pin 0, detector B from the PCS transmit path is detected at port A pin 1, detector C from the AMPS receive path is detected at port A, pin 2, and detector D from the AMPS transmit path is detected at port A pin 3. Pins 6 and 7 of port A are used to control the LED relating to the PCS system. Pins 4 and 5 of Port B are used to control the LED relating to the AMPS system. Pins 0, 2, and 3 of Port B are used to communicate with the digital potentiometer and to set the attenuation levels for the attenuators E-H.

Thus, one or more of the embodiments herein detailed provides a wireless enhancer that is useful in assisting in communicating with a previously established communication network, such as a cell phone network. In regions of low signal strength, the wireless enhancer may boost a received signal so that a user on a cell phone may maintain a conversation, for example. Additionally, the wireless enhancer may provide amplification for the user's transmitted signal to assist in maintaining the conversation. Also, as detailed in FIG. 2, the wireless enhancer seeks to provide the highest amplification without producing an overdriven or oscillation condition.

Thus, the wireless enhancer may be positioned in an automobile, for example, and may be used to increase the ability of a user to communicate with an existing cell phone system, such as a PCS, AMPS, or iDEN system. The wireless enhancer provides bidirectional amplification for multiple signal formats and self-monitors to deliver the maximum amplification to the user without creating an oscillation or overdriven condition.

While particular elements, embodiments and applications of the present invention have been shown and described, it will be understood that the invention is not limited thereto since modifications may be made by those skilled in the art, particularly in light of the foregoing teachings. It is therefore contemplated by the appended claims to cover such modifications as incorporate those features which come within the spirit and scope of the invention.

1. A communication system including:
a first bidirectional amplification system for using a first communication format, said first bidirectional amplification system including:
a first format transmit pathway; and
a first format receive pathway; and
a second bidirectional amplification system using a second communication format, said second bidirectional amplification system including:
a second format transmit pathway; and
a second format receive pathway,
wherein each of said first and second format pathways includes:
a signal power detector;
an attenuator; and
an amplifier.

2. The system of claim 1 wherein one of said first format and said second format is the AMPS format.

3. The system of claim 1 wherein one of said first format and said second format is the PCS format.

4. The system of claim 1 wherein one of said first format and said second format is the iDEN format.

5. The system of claim 1 further including a microprocessor, wherein said microprocessor uses one of said signal power detectors to determine the signal power for one of said pathways.

6. The system of claim 1 further including a microprocessor, wherein said microprocessor controls one of said attenuators to reduce the signal power for one of said pathways.

7. A communication method including:
establishing a communication pathway for passing a signal through an amplifier, an attenuator, and a detector;
establishing an overpower threshold for said pathway;
sampling the signal power of said signal on said pathway using said detector;
comparing said signal power to said overpower threshold; and
when said signal power is greater than said overpower threshold, increasing the attenuation of said attenuator.

8. The method of claim 7 wherein said signal is an AMPS signal.

9. The method of claim 7 wherein said signal is a PCS signal.

10. The method of claim 7 wherein said signal is an iDEN signal.

11. The method of claim 7 further including:
setting an overdrive flag.

12. The method of claim 11 further including:
when said signal power is less than said overpower threshold, determining if an overdriven flag has been set; and
when said overdrive flag has been set, increasing the attenuation of said attenuator.

13. The method of claim 7 further including:
determining an attenuation for said attenuator that causes said signal power to be less than said overpower threshold.

14. The method of claim 13 further including:
increasing the attenuation of said attenuator beyond said attenuation that causes said signal power to be less than said overpower threshold.

15. The method of claim 7 wherein said signal is an DCS 1800 signal.

16. The method of claim 7 wherein said signal is an GSM 900 signal.

17. A communication method including:
establishing a first communication pathway, said first pathway passing a first signal from a first antenna to a second antenna through a first amplifier, a first attenuator, and a first detector;
establishing a second communication pathway, said second pathway passing a second signal from said first antenna to said second antenna through a second amplifier, a second attenuator, and a second detector;
establishing a first overpower threshold for said first pathway;
establishing a second overpower threshold for said second pathway;
when said first pathway is in use,
measuring the power of said first signal using said first detector;
comparing said power of said first signal to said first overpower threshold;
increasing the attenuation of said first attenuator when said power of said first signal exceeds said first overpower threshold; and
when said second pathway is in use,
measuring the power of said second signal using said second detector;
comparing said power of said second signal to said second overpower threshold;
increasing the attenuation of said second attenuator when said power of said second signal exceeds said second overpower threshold.

18. The method of claim 17 wherein said first communication pathway uses a first communication format and said second communication pathway uses a second communication format.
